(19) United States
(12) Patent Application Publication
(10) Pub. No.: US 2015/0082157 A1
(43) Pub. Date: Mar. 19, 2015

(54) METHOD AND DEVICE FOR REALIZING OPERATIONS BETWEEN DEVICES

(71) Applicant: Samsung Electronics Co., Ltd., Gyeonggi-do (KR)

(72) Inventor: Lanlan ZHANG, Beijing (CN)

(73) Assignee: Samsung Electronics Co., Ltd.

(21) Appl. No.: 14/487,697

(22) Filed: Sep. 16, 2014

(30) Foreign Application Priority Data
Sep. 16, 2013 (CN) 201310421742.7
Mar. 24, 2014 (KR) 10-2014-0034238

(51) Int. Cl. G06F 17/24; G06F 3/0484; G06F 3/0481

(52) U.S. Cl. CPC G06F 17/24; G06F 3/04812; G06F 3/04842
USPC 715/255

(57) ABSTRACT

A method of and device for performing edit operations between devices is provided. The device includes a second device for receiving an operation object from a first device via a communication connection between the first device and the second device, and the second device performing an edit operation for the operation object, wherein the edit operation includes saving the operation object to a clipboard, and inputting the operation object into a current edit box.

### PRIORITY

This application claims priority under 35 U.S.C. 119(a) to a Chinese Patent Application filed on Sep. 16, 2013 in the Chinese Intellectual Property Office and assigned Serial No. 201310421742.7, and a Korean Patent Application filed on Mar. 24, 2014 in the Korean Intellectual Property Office and assigned Serial No. 10-2014-0034238, the entire contents of each of which are incorporated herein by reference.

### BACKGROUND

1. Field of the Invention

The present invention relates generally to mobile communications, and more particularly, to a method of and device for performing edit operations between devices.

2. Description of Related Art

Copy, paste, and cut are three basic edit operations widely used in electronic devices. Existing copy, paste, and cut methods of information sharing between devices mainly include the following methods.

A first method includes copy and paste operations on a local, stand-alone device. This method has a problem in that it may only be performed on a single device. In addition, operating across, and sharing information between, devices cannot be accomplished.

A second method includes copy and paste operations in a cloud environment. This method has a problem of requiring a cloud server. In addition, the copied or pasted content must be uploaded to the cloud server before it may be copied or pasted. Furthermore, interaction with the cloud server and sharing data across devices may only be accomplished when the data network is accessible. Moreover, the method is inconvenient to operate, because the cloud server must first retrieve logon information of an end user before performing the copy or paste operation. In addition, operating across, and sharing information between, devices is tedious. For example, a user of device A must log onto a cloud server using an account before copying content to the cloud server. A user of device B must then log onto the cloud server using the same account and paste the target content to device B. Due to privacy policies of mobile devices, this method is inconvenient.

A third method includes transmitting information via messages (e.g., short messages, multi-media messages, etc.). In this method, the receiver of a message performs a local cut and paste operation. The method involves the receiver receiving information via a message (e.g., a short message, a multi-media message, etc.), copying the target content to a clipboard, opening a target application program, selecting the content from the clipboard, and pasting the content into the target application program. The problems with this method include sending a message, where the transmission efficiency may be low, and the steps being inconvenient to the user.

A fourth method includes two parties accessing the Internet, transmitting information using a chat tool, and performing a local copy or paste operation on information received via the chat tool. The method involves both users accessing a data network, both users logging onto a chat tool, at least one of the users receiving information, the receiving user copying the target content to a clipboard, the receiving user opening a target application program, the receiving user selecting the target content from the clipboard, and the receiving user pasting the target content into the target application program. The problems with this method include being dependent on a network and the steps being inconvenient to the users.

### SUMMARY

The present invention has been made to address at least the above-mentioned problems and disadvantages, and to provide at least the advantages described below. Accordingly, an aspect of the present invention is to provide a method of and device for performing edit operations between devices to improve the convenience of edit operations between two or more devices.

According to an aspect of the present invention, a method of performing an edit operation between devices is provided. The method includes receiving, by a second device, an operation object from a first device via a communication connection between the first device and the second device, and performing, by the second device, the edit operation on the operation object, wherein the edit operation comprises saving the operation object to a clipboard, and inputting the operation object into a current edit box.

According to another aspect of the present invention, a device for performing an edit operation between devices is provided. The device includes a communication module configured to receive an operation object from a first device via a communication connection to the first device, and a command identification module configured to perform the edit operation for an operation object, wherein the edit operation includes saving the operation object to a clipboard, and inputting the operation object into a current edit box.

According to another aspect of the present invention, a method of performing an edit operation between devices is provided. The method includes detecting by a first device an operation object selected by a user, wherein the operation object is used for the edit operation including saving the operation object to a clipboard, and inputting the operation object into a current edit box, wherein the operation object selected by the user comprises is detected from the clipboard, the current edit box, a file folder, or an application program display interface, and wherein the operation object comprises text, an image, audio, or video, and sending, by the first device, the operation object to a second device via a communication connection between the first device and the second device.

According to another aspect of the present invention, a device for performing an edit operation between devices is provided. The device includes a detection module configured to detect an operation object selected by a user, wherein the operation object is configured to perform the edit operation, and wherein the edit operation includes saving the operation object to a clipboard, and saving the operation object into a current edit box, and a communication module configured to send the operation object to a second device via a communication connection to the second device.

According to another aspect of the present invention, a method of performing an edit operation between devices is provided. The method includes sending, by a first device, a request to a second device and receiving a corresponding operation object from the second device via a communication connection between the first device and the second device, and performing, by the first device, the edit operation for the operation object, wherein the edit operation includes saving the operation object to a clipboard, and inputting the operation object into a current edit box.

According to another aspect of the present invention, a device for performing an edit operation between devices is provided. The device includes a communication module configured to send a request to a second device and receive a corresponding operation object from the second device via a communication connection to the second device, and an edit module configured to perform the edit operation on an operation object, wherein the edit operation includes saving the operation object to a clipboard, and inputting the operation object into a current edit box.

According to another aspect of the present invention, a method of performing an edit operation between devices is provided. The method includes receiving, by a second device, a request from a first device via a communication connection between the first device and the second device, sending, by the second device, an operation object requested by the first device to the first device to perform the edit operation, wherein the edit operation includes saving the operation object to a clipboard, and inputting the operation object into a current edit box, wherein the operation object is an operation object corresponding to an edit command on the first device.

According to another aspect of the present invention, a device for performing an edit operation between devices is provided. The device includes a communication module configured to receive a request from a first device via a communication connection with the first device, and a command identification module configured to send an operation object request by the first device to the first device to perform the edit operation via the communication module, wherein the edit operation includes saving the operation object to a clipboard, and inputting the operation object into a current edit box.

### BRIEF DESCRIPTION OF THE DRAWINGS

The above and other aspects, features, and advantages of the present invention will be more apparent from the following description taken in conjunction with the accompanying drawings, in which:

FIG. 1 is a schematic diagram of performing edit operations between two devices of the present invention;

FIG. 2 is a schematic diagram of performing edit operations among multiple devices of the present invention;

FIG. 3 is a flowchart of a method of performing edit operations between devices of the present invention;

FIG. 4A is a schematic diagram of a first device of the present invention;

FIG. 4B is a schematic diagram of a second device of the present application;

FIG. 5 is a flowchart of a method of performing edit operations between devices of the present invention;

FIG. 6A is a schematic diagram of the a first device of the present invention;

FIG. 6B is a schematic diagram of a second device of the present invention;

FIG. 7 is a schematic diagram of a device of the present invention;

FIG. 8 is a flowchart for performing a copy-to-remote-end command between two devices of the present invention;

FIG. 9 is a flowchart for performing a copy-from-remote-end command between two devices of the present invention;

FIGS. 10A and 10B are flowcharts for performing a paste-to-remote-end command between two devices of the present invention;

FIG. 11 is a flowchart for performing a paste-from-remote-end command between two devices of the present invention;

FIG. 12 is a flowchart for performing a cut-to-remote-end command between two devices of the present invention; and

FIGS. 13A and 13B are flowcharts for performing a cut-from-remote-end command between two devices of the present invention.

### DETAILED DESCRIPTION OF EMBODIMENTS OF THE PRESENT INVENTION

In order to assist in the comprehensive understanding of the aspects and advantages of the present invention, the present invention is described in further detail hereinafter with reference to the accompanying drawings and embodiments.

The present invention provides a method of and device for performing edit operations between two or more devices using a wireless transmission technique or wired transmission technique such as Wireless Fidelity (Wi-Fi), Bluetooth, Near Field Communication (NFC), sound waves, etc.

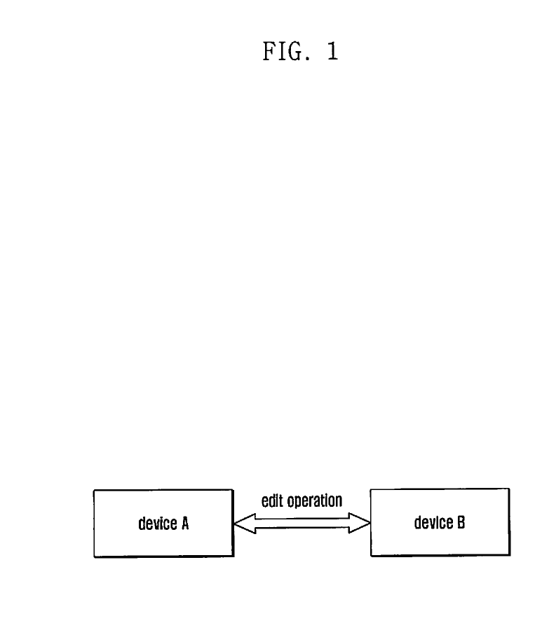

FIG. 1 is a schematic diagram of performing edit operations between two devices of the present invention.

Referring to FIG. 1, the two devices include a device A and a device B, between which an edit operation is performed.

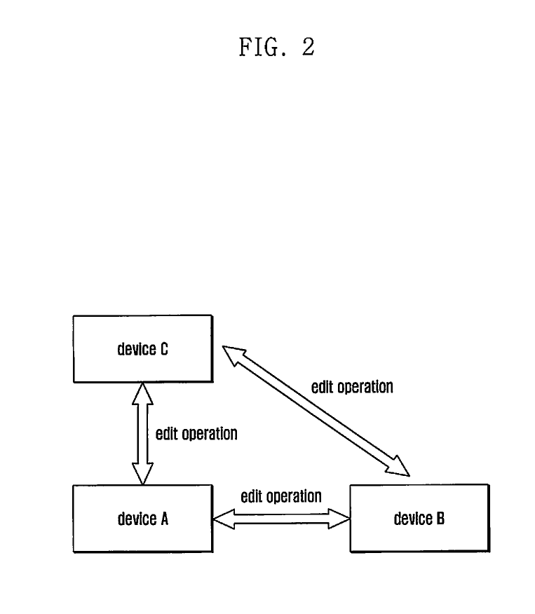

FIG. 2 is a schematic diagram of performing edit operations among multiple devices of the present invention.

Referring to FIG. 2, the multiple devices include a device A, a device B, and a device C, between which edit operations are performed.

In the present invention, an operation object of an edit operation may be any format (e.g., text, image, audio, video, etc.).

In the present invention, edit commands are used to perform the edit operations on the operation objects, wherein the edit operations include saving an operation object to a clipboard, and/or inputting an operation object to a current edit box. Thus, the present invention discloses several edit commands including copy-to-remote-end, paste-to-remote-end, cut-to-remote-end, copy-from-remote-end, paste-from-remote-end, and cut-from-remote-end.

Copy-to-remote-end, paste-to-remote-end, and cut-to-remote-end are for sending an operation object of the present invention to other devices to perform corresponding edit operations (i.e., sending the operation object to another device, where the other device saves the operation object to a clipboard, and/or inputs the operation object into a current edit box).

Copy-from-remote-end, paste-from-remote-end, and cut-from-remote-end commands are for retrieving an operation object from another device (i.e., remote device) and performing corresponding edit operations at the present device (i.e., non-remote device). The steps of this method include retrieving the operation object from the other device, saving the retrieved operation object to a clipboard of the present device, and/or inputting the operation object into a current edit box of the present device.

The two types of edit operations described above are illustrated in detail hereafter in combination with the accompanying drawings.

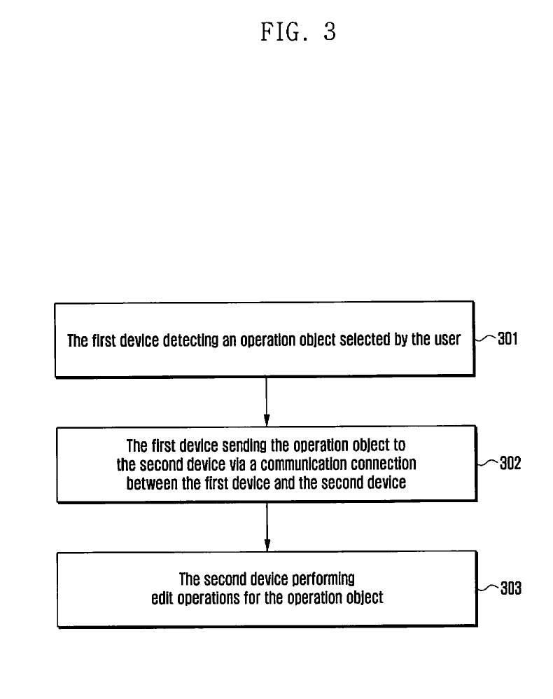

FIG. 3 is a flowchart of a method of performing edit operations between devices of the present application.

Referring to FIG. 3, step 301 is a first device for detecting an operation object selected by a user, using the operation object for editing, saving the operation object to a clipboard, and/or inputting the operation object into a current edit box.

The operation object may be selected from the clipboard, current edit box, file folder, or application program display interface. In addition, the operation object may be selected from a variety of environments such as a web page, electronic book, etc.

In step 301, the first device detects an edit command selected by the user which is to be used to perform an edit operation on the operation object. The edit command includes at least one of the following commands: copy-to-remote-end, paste-to-remote-end, and cut-to-remote-end.

In step 302, the first device sends the operation object to the second device via a communication connection between the first device and the second device.

If, in step 301, the first device detected the edit command then, in step 302, the first device sends the edit command to the second device.

In the embodiments of the present invention, the communication connection between the devices includes various communication connections (e.g., wired connection wireless connection, wherein the wireless connection may be a wireless communication method based on Bluetooth, Wi-Fi, NFC, etc., which are not described herein).

In an embodiment of the present invention, after the first device detects an edit command of the user, the first device establishes a communication connection with the second device, and sends the operation object and the edit command to the second device. If there is an existing communication connection between the first device and the second device, the first device sends the operation object and the edit command to the second device via the existing communication connection.

If the edit command is cut-to-remote-end then the first device performs a cut operation on the operation object.

In step 303, the second device performs edit operations on the operation object, wherein the edit operations include saving the operation object to the clipboard, and/or inputting the operation object into the current edit box.

After the second device receives the operation object, it processes the operation object according to a default edit operation method, and may also process the operation object according to a randomly selected edit operation method, wherein the edit operation method includes saving the operation object to the clipboard, and/or inputting the operation object into the current edit box.

After the second device receives the operation object, it processes the operation object according to the following focus detecting method.

The first step of the focus detecting method determines whether there is an edit box with focus and, if there is, inputs the operation object to the current edit box at a location indicated by a cursor. Otherwise, operation object is saved to the clipboard, and the user is notified that the operation object has been saved to the clipboard. Subsequently, a corresponding operation is performed according to the user's command, or, it is determined whether the operation object has an identity indicating that it is a target application program, and, if it is, the target application program is opened and the operation object is put into the edit box of the target application program. The process generally includes opening a target application program. If the target application program corresponding to the operation object is identified as a short message then when the operation object is received, a short message is created and the content of the operation object is put into the short-message edit box. If the operation object is a Uniform Resource Locator (URL) address and the corresponding target application program is identified as a browser then the browser is opened, the operation object is put into the address column of the browser, and a corresponding web page is opened.

If the second device receives an edit command from the first device then the second device performs a corresponding edit operation on the operation object.

For different edit commands selected by the user at the first device (e.g., copy-to-remote-end, paste-to-remote-end, cut-to-remote-end, etc.), the operations performed by the second device for the operation object may be different.

If the edit command is copy-to-remote-end or cut-to-remote-end then, when the second device receives the operation object, the second device saves the operation object to a clipboard according to the edit command, and notifies the user that the operation object has been saved to the clipboard. Subsequently, the second device performs an operation according to the user's command or inputs the operation object into the current edit box at a location indicated by a cursor.

If the edit command is paste-to-remote-end then the second device inputs the operation object into the current edit box at a location indicated by the cursor or saves the operation object to the clipboard and inputs the operation object into the current edit box at a location indicated by the cursor.

In the method disclosed in FIG. 3, operations of the edit operation initiator (i.e., the first device) and operations of the edit operation receiver (i.e., the second device) are disclosed. The operations performed by the edit operation initiator and receiver are described below from each perspective.

From the perspective of the edit operation initiator (i.e., the first device), operations performed by the edit operations initiator include detecting an operation object selected by the user; using the operation object for performing edit operations, wherein the edit operations include saving the operation object to the clipboard, and/or inputting the operation object into the current edit box; and sending the operation object to the second device via a communication connection between the first device and the second device.

For the edit operation receiver (i.e., the second device), operations to be performed include receiving the operation object from the first device via the communication connection between the first device and the second device, and the second device performing edit operations for the operation object, wherein the edit operations include saving the operation object to the clipboard, and/or inputting the operation object into the current edit box.

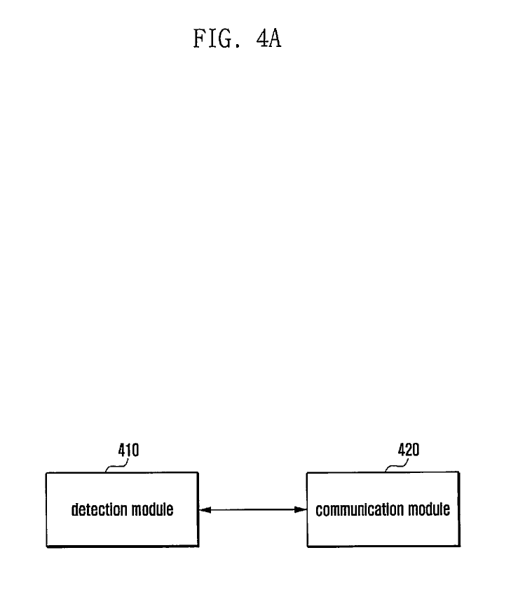

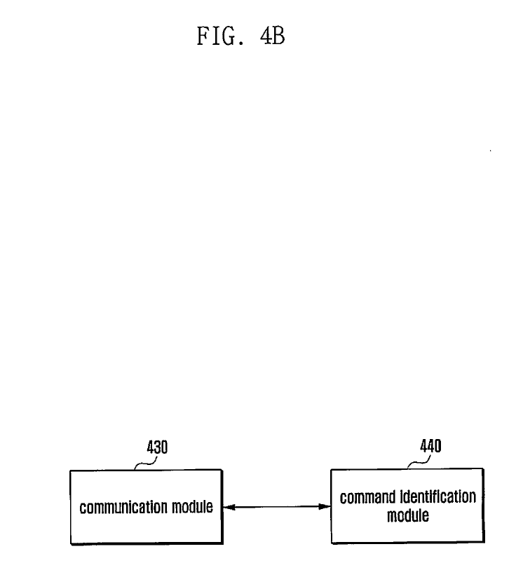

Corresponding to the first device in the above method, the present invention includes a device for performing edit operations between devices as shown in FIG. 4A.

FIG. 4A is a schematic diagram of the first device of the present invention.

Referring to FIG. 4A, the first device includes a detection module 410 and a communication module 420.

The detection module 410 is configured to detect an operation object selected by the user. The operation object is used for performing edit operations, wherein the edit operations include saving the operation object to the clipboard, and/or inputting the operation object into the current edit box.

The communication module 420 is configured to send the operation object to the second device via the communication connection between the first device and the second device.

When the detection module 410 detects the operation object selected by the user, the detection module 410 selects the operation object from the clipboard, the current edit box, file folders or an application program display interface, where the operation object type includes text, image, audio, video, etc.

The detection module 410 is further configured to detect edit commands selected by the user, where the edit commands are used to perform edit operations for the operation object.

The communication module 420 is further configured to send the edit commands to the second device.

If the edit command is cut-to-remote-end then the first device includes an edit module configured to cut the operation object.

Corresponding to the second device in the above method, the present invention discloses a device for performing edit operations between devices as shown in FIG. 4B.

FIG. 4B is a schematic diagram of the second device of the present invention.

Referring to FIG. 4B, the second device includes a communication module 430 and a command identification module 440.

The communication module 430 is configured to receive the operation object from the first device via the communication connection between the second device and the first device.

The command identification module 440 is configured to perform edit operations on the operation object, where the edit operations include saving the operation object to the clipboard, and/or putting the operation object into the current edit box.

The command identification module 440 is also configured to determine whether there is an edit box with focus and, if there is, put the operation object into the edit box at a location indicated by a cursor, otherwise, save the operation object to the clipboard, or determine whether the operation object has an identity indicating a target application program, and, if it has, open the corresponding target application program and put the operation object into the edit box of the target application program.

The communication module 430 is further configured to receive edit commands from the first device.

The command identification module 440 is further configured to perform edit operations on the operation object according to the edit commands.

If the edit command is copy-to-remote-end or cut-to-remote-end then the command identification module 440 is further configured to save the operation object to the clipboard, or input the operation object into the current edit box at a location indicated by the cursor.

If the edit command is paste-to-remote-end, the command identification module 440 is configured to put the operation object into the current edit box at a location indicated by the cursor, or save the operation object to the clipboard and put the operation object into the current edit box at a location indicated by the cursor.

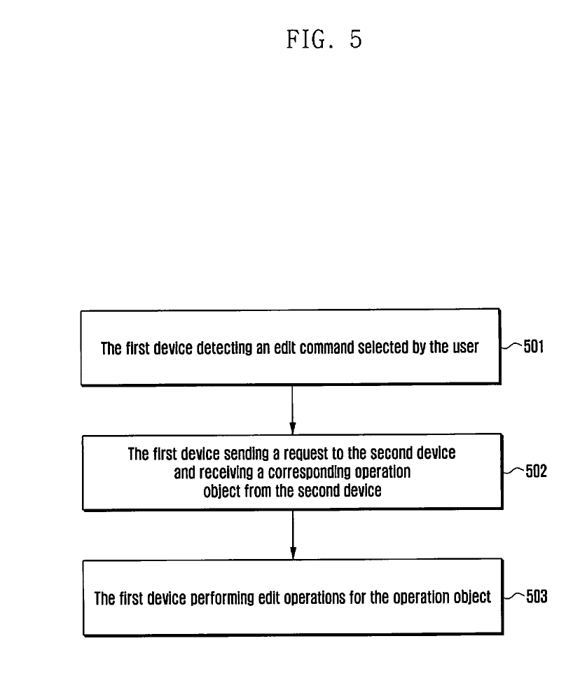

FIG. 5 is a flowchart of a method of performing edit operations between devices of the present invention.

Referring to FIG. 5, in step 501, the first device detects an edit command selected by a user.

Step 501 is optional, and the present method may start with step 502.

The edit command includes at least one of the following commands: copy-from-remote-end, paste-from-remote-end, and cut-from-remote-end. The copy-from-remote-end or cut-from-remote-end command may be initiated from the clipboard. The paste-from-remote-end command may be initiated from the edit box of an application program. For the cut-from-remote-end command, the first device must obtain authorization from the second device to perform the cut operation on the operation object in the second device.

In step 502, the first device sends a request to the second device and receives a corresponding operation object from the second device via the communication connection between the first device and the second device.

If, in step 501, the first device detects the edit command selected by the user then, in step 502, the first device sends a request to the second device in accordance with the edit command.

Prior to step 502, an operation object must be identified. The present invention includes two methods of identifying an operation object.

The first method of identifying an operation object includes the first device obtaining an operation object list from the second device, where the operation object list includes abstract information of operation objects in the second device that may be edited by another device. The operation object list may be in the clipboard of the second device.

The first device detects abstract information of an operation object selected by the user from the operation object list.

The first device requests authorization from the second device to obtain the operation object corresponding to the abstract information selected by the user via a communication connection between the first device and the second device.

In this method, the second device may preset content in the clipboard that is accessible to another device, where the other device may obtain the operation object list of the second device. The operation object list contains abstract information of operation objects. For text, the abstract information may be the first 10 words of the text. For an image, the abstract information may be a compressed version of the image, which reduces transmission bandwidth and improves transmission efficiency.

The second method of identifying an operation object includes the first device sending an edit command selected by the user to the second device via the communication connection between the first device and the second device.

The second device notifies the user to select an operation object, and when the second device detects that an operation object has been selected by the user, the second device sends the operation object selected by the user to the first device.

After the second device receives the edit command sent from the first device, it opens a clipboard from which the user selects an operation object. The operation object may be selected by dragging or selecting, and confirming.

As in step 302, the first device establishes the communication connection with the second device after it detects the edit command of the user and interacts with the second device based on the communication connection. The first device may also interact with the second device based on an existing communication connection between the first device and the second device.

In step 503, the first device performs an edit operation on the operation object, where the edit operation includes saving the operation object to the clipboard and/or putting the operation object into the current edit box.

In step 503, the first device performs an edit operation on the operation object as the second device performed an edit operation on the operation object in step 303 (i.e., the first device processes the operation object according to a default edit operation, a randomly selected edit operation, or a focus detecting method, which will not be described herein).

If, in step 501, the first device detects the edit command selected by the user then, in step 503, the first device performs an edit operation on the operation object according to the edit command.

In step 503, if the edit commands selected by the user are different then the operations performed on the operation object by the first device may be different.

If the edit command is copy-from-remote-end or cut-from-remote-end then after the first device receives the operation object, the first device saves the operation object to the clipboard, and notifies the user that a new operation object was added to the clipboard. Subsequently, the first device may perform operations according to the user's commands or may put the operation object into the current box at a location indicated by a cursor.

If the edit command is paste-from-remote-end then after the first device receives the operation object, the first device puts the operation object into the current edit box at a location indicated by the cursor, or saves the operation object to the clipboard and puts the operation object into the current edit box indicated by the cursor.

The method disclosed in FIG. 5 contains operations of the edit operation initiator (i.e., the first device) and operations of the edit operation receiver (i.e., the second device). The operations performed by the edit operation initiator and edit operation receiver are described below from each perspective.

From the perspective of the edit operation initiator (i.e., the first device), the operations performed by the first device include sending a request to the second device, receiving a corresponding operation object from the second device via the communication connection between the first device and the second device, and performing edit operations on the operation object, where the edit operations include saving the operation object to the clipboard and/or putting the operation object into the current edit box.

From the perspective of the edit operation receiver (i.e., the second device), the operations performed by the second device include receiving the request from the first device via the communication connection between the first device and the second device, and sending the operation object requested by the first device to the first device to perform edit operations, where the edit operations include saving the operation object to the clipboard and/or putting the operation object into the current edit box.

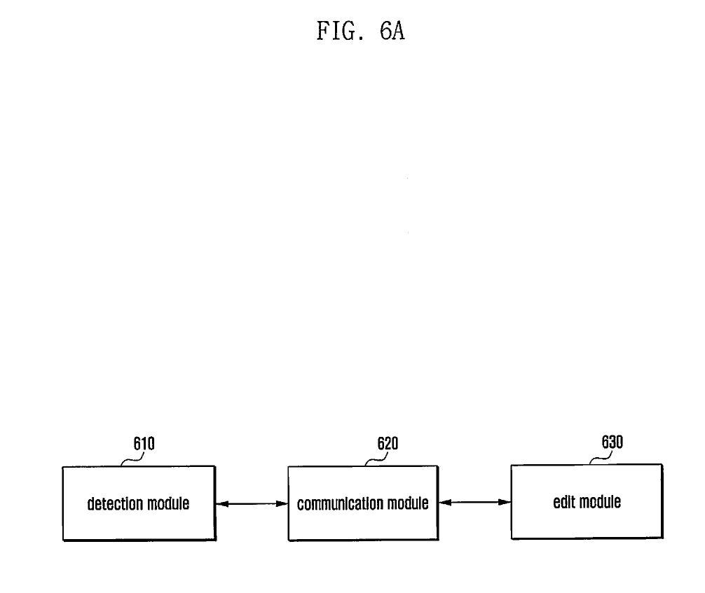

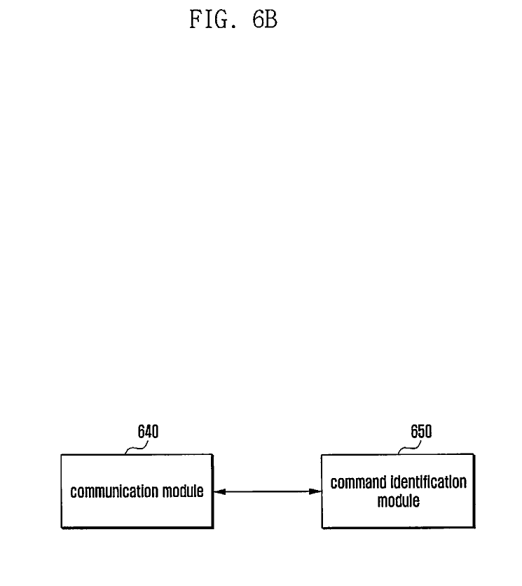

Corresponding to the first device in the method disclosed in FIG. 5, the present invention discloses a device for performing edit operations between devices as shown in FIG. 6A.

FIG. 6A is a schematic diagram of a first device of the present application.

Referring to FIG. 6A, the first device includes a detection module 610, a communication module 620 and an edit module 630

The detection module 610 is configured to detect an edit command selected by the user.

The detection module 610 is also configured to detect the abstract information of the operation object selected by the user from the operation object list. The communication module 620 is configured to send a request to the second device and receiving a corresponding operation object from the second device via the communication connection between the current device and the second device.

The edit module 630 is configured to perform edit operations on the operation object, where the edit operations include saving the operation object to the clipboard and/or putting the operation object into the current edit box.

The edit module 630 is also configured to determine whether there is an edit box with focus and, if there is, put the operation object into the edit box at a location indicated by a cursor or otherwise, save the operation object to the clipboard, or determine whether the operation object has an identity indicating a target application program, and, if there is, open the corresponding target application program and put the operation object into the edit box of the target application program.

The communication module 620 is further configured to send a request to the second device according to the edit command.

The edit module 630 is further configured to perform a corresponding edit operation on the operation object according to the edit command.

The communication module 620 is configured to obtain an operation object list from the second device, where the operation object list contains abstract information of operation objects that may be edited by another device.

The communication module 620 is further configured to send a request to the second device to request authorization for obtaining an operation object corresponding to the abstract information selected by the user.

The communication module 620 is configured to send the edit command selected by the user to the second device and receive an operation object selected by the user after it informs the user of the edit command.

If the edit command is copy-from-remote-end or cut-from-remote-end, the edit module 630 is configured to save the operation object to the clipboard or put the operation object into the current edit box at a location indicated by the cursor.

If the edit command is paste-from-remote-end then the edit module 630 is configured to put the operation object into the current edit box at a location indicated by the cursor, or save the operation object to the clipboard and put the operation object into the current edit box at a location indicated by the cursor.

As for the second device in the method shown in FIG. 5, the present invention discloses a device for performing edit operations between devices as shown in FIG. 6B.

FIG. 6B is a schematic diagram of a second device of the present invention.

Referring to FIG. 6B, the second device includes a communication module 640 and a command identification module 650.

The communication module 640 is configured to receive a request from the first device via the communication connection between the current device and the first device.

The command identification module 650 is configured to send the operation object requested by the first device to the first device to perform edit operations via the communication module 640, where the edit operations include saving the operation object to the clipboard, and/or putting the operation object into the current edit box.

The operation object is an operation object corresponding to the edit command on the first device.

The communication module 640 is configured to send an operation object list to the first device, where the operation object list contains abstract information of operation objects that may be edited by another device, receive a request from the first device for an operation object in the operation object list, and send the operation object requested by the first device to the first device.

The communication module 640 is configured to receive an edit command from the first device.

The command identification module 640 is configured to notify the user to select an operation object according to the edit command and detect the operation object selected by the user.

The communication module 640 is further configured to send the operation object selected by the user to the first device.

If the edit command is cut-from-remote-end, the second module further includes an authorization module and an edit module, where the authorization module is configured for authorizing the first device to perform a cut operation for the operation object, and where the edit module is configured for cutting the operation object.

The method provided by the present invention may be implemented in hardware or software (e.g., the functions may be supported after the user downloads software).

Other embodiments of the present invention are described below.

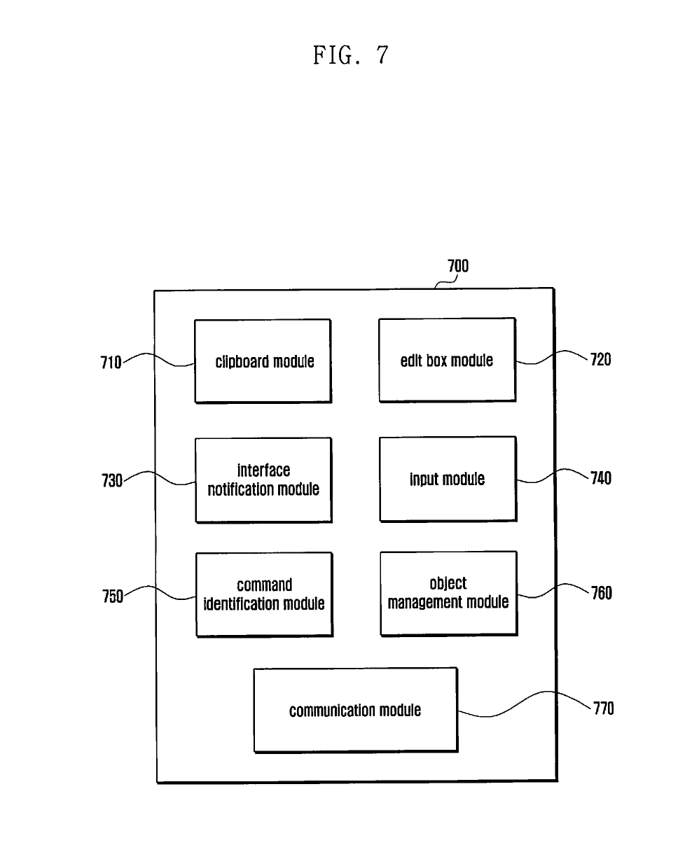

FIG. 7 is a schematic diagram of the structure of a device of an embodiment of the present invention.

Referring to FIG. 7, the device 700 includes a clipboard module 710, an edit box module 720, an interface notification module 730, an input module 740, a command identification module 750, an object management module 760, and a communication module 770.

The clipboard module 710 is configured to save data that has been copied to a storage device, where the data is used for data-paste-inside or data-sharing-outside commands. The data-paste-inside command refers to a command for pasting data within a single device, where the content of a clipboard may be pasted among multiple application programs. The data-sharing-outside command refers to a command for the content of the clipboard of one device to be copied, or input, into the clipboard or edit box module 720 area of another device.

The edit box module 720 is an edit area at a location indicated by a cursor and is a module that may receive information such as text, image, audio, video, etc.

The interface notification module 730 is a module for prompting the user after background data has been sent or received.

The input module 740 puts received data into the edit box module 720.

The command identification module 750 is configured to identify remote edit commands including 1) copy-to-remote-end; 2) copy-from-remote-end; 3) paste-to-remote-end; 4) paste-from-remote-end; 5) cut-to-remote-end; and 6) cut-from-remote-end.

The object management module 760 is configured to manage the remote device.

The communication module 770, based on a wireless protocol, sends content to a remote device or receives content in the local device. The communication module 770 may also be based on a wired protocol.

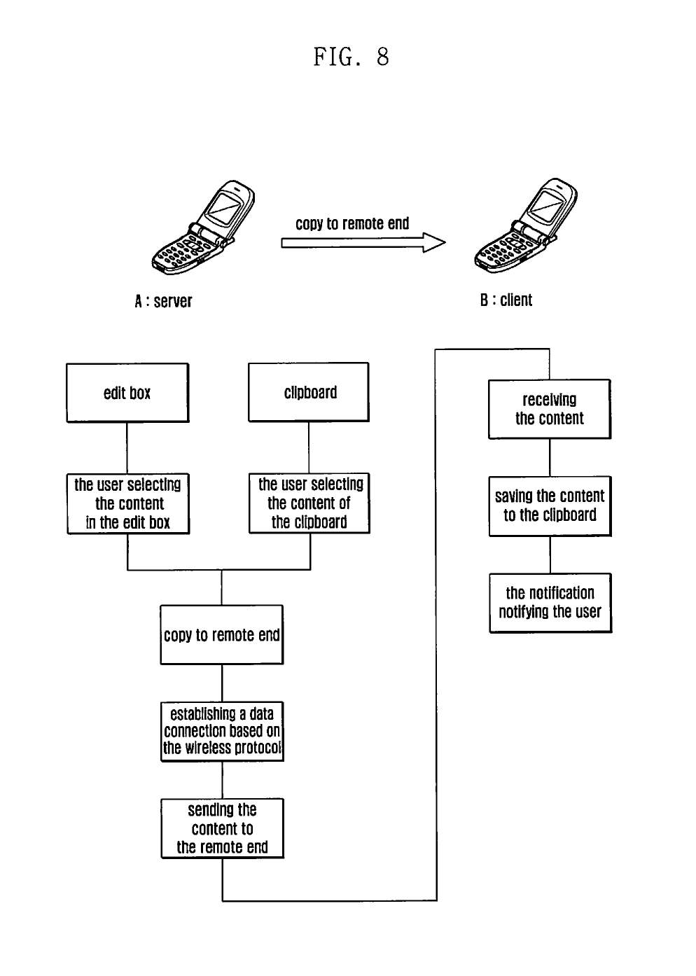

FIG. 8 is a flowchart for performing a copy-to-remote-end command between two devices of the present invention.

Referring to FIG. 8, device A initiates a copy-to-remote-end command to device B to realize copying of an operation object in device A to device B. In the embodiment, device A is a server (i.e., Server A), and device B is a client (i.e., Client B). The operation of the server and the client is described below.

In Server A (also known as the initiator or the sender), the user selects the content of an edit box module or the content of a clipboard module as the target content (i.e., the operation object mentioned above). The user confirms the copy-to-remote-end command. After the command identification module receives the command, it notifies the object management module to establish a connection with the remote device (i.e., device B). After the connection is established, the edit box module or clipboard module sends the target content to the communication module, and the communication module sends the target content to the client.

In Client B (also referred to as the receiver), after the communication module receives the data, it notifies the clipboard module to save the data, and, after the clipboard saves the data, the interface notification module notifies the user that the data has been received.

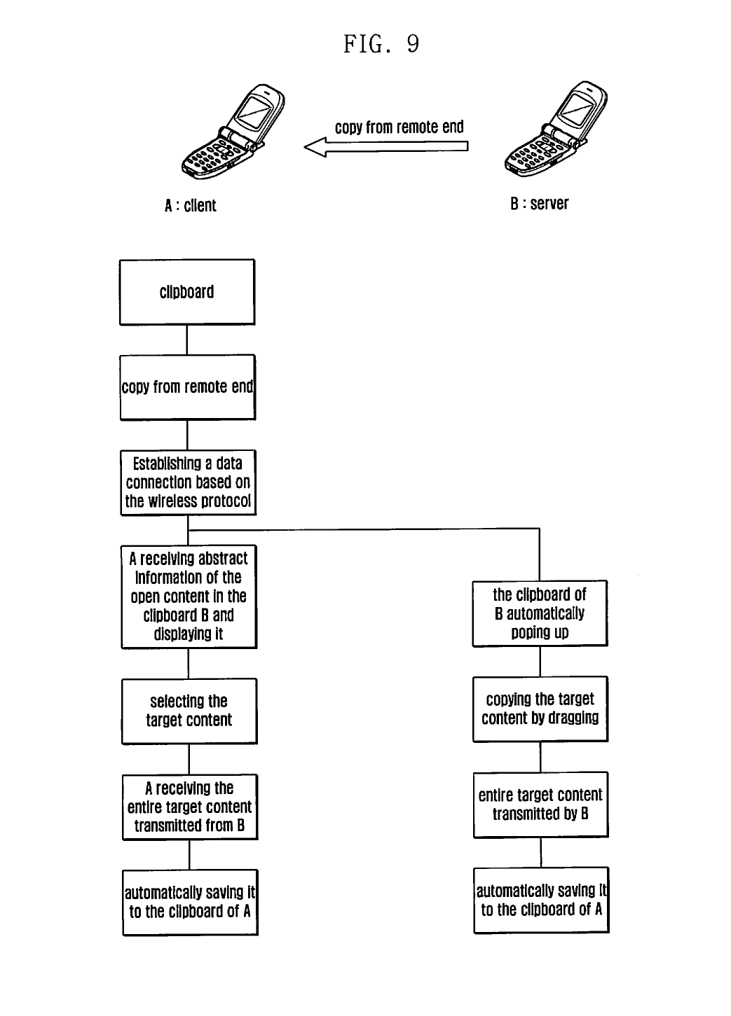

FIG. 9 is a flowchart for performing a copy-from-remote-end command between two devices of the present application.

Referring to FIG. 9, device A initiates the copy-from-remote-end command to device B, and copies the operation object in device B to device A. In the present embodiment, device B is a server (i.e., Server B) and device A is a client (i.e., Client A). The operation of the server and the client is described below.

In Server B, in consideration of the data security problem, device B (or end B) sets the content in the clipboard that is open to the other device (i.e., the content that may be copied to the remote end).

In Client A, in the clipboard module, the user selects the copy-from-remote-end command and, after the command identification module receives the command, the command identification module notifies the object management module to establish a connection with the remote device (i.e., Server B).

The data exchange between device A and device B may be divided into two modes.

In the first mode, after a data connection is established, device A receives abstract information of the open content of device B and, to reduce transmission bandwidth and improve transmission efficiency, device B only transmits a portion of the content to device A. For text, only the first 10 words of the text may be transmitted. For an image, the image may be compressed before being transmitted. After device A receives the abstract information, it displays it on device A. The user selects the target content at device A. After the command identification module receives the command, it notifies the communication module of device B to send the entire data to device A. After the communication module of device A receives the data from device B, device A saves it to the clipboard module of device A.

In the second mode, after the data connection is established, the clipboard of device B open, and the user confirms the target content from device B via dragging or selecting, and confirming, etc. After the instruction identification module identifies the command, it notifies the communication module to send the target content to device A. After the reception module of device A receives the content, it saves it to the clipboard of device A.

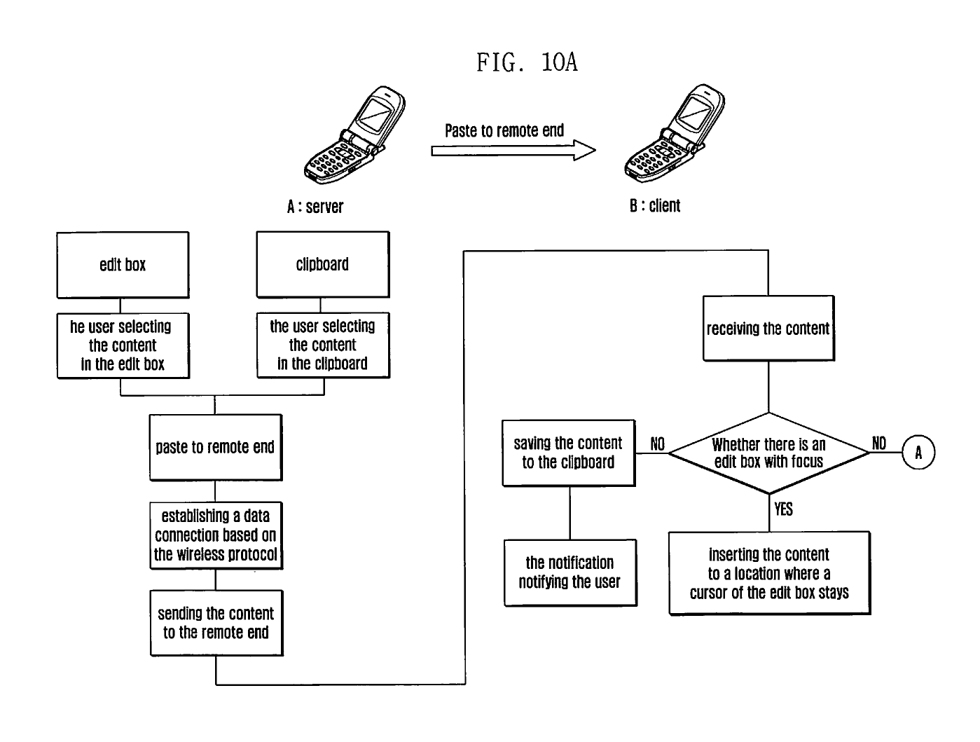

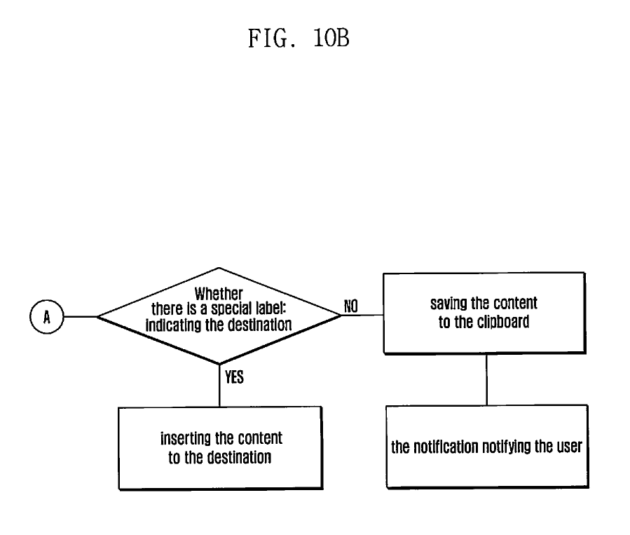

FIGS. 10A and 10B are flowcharts for performing the paste-to-remote-end command between two devices of the present invention.

Referring to FIGS. 10A and 10B, device A sends a paste-to-remote-end command to device B to input an operation object to device B. In the embodiment, device A is a server (i.e., Server A), and device B is a client (i.e., Client B). The operation of Server A and Client B is described below.

In Server A, the user selects the content of an edit box module or the content of a clipboard module as the target content. The user confirms the paste-to-remote-end command. After the command identification module receives the command, it notifies the object management module to establish a connection with the remote device and, after the connection is established, obtains the target content from the edit box module or the clipboard module and transmits it to Client B.

In Client B, after the communication module receives the data, Client B determines whether there is an edit box with focus and, if there is, the input module puts the received target content into the edit box.

If there is no edit box with focus then there are two methods for processing the target content.

In the first method, the clipboard module saves the data, and the interface identification module notifies the user that data was received.

In the second method, it is determined whether there is an identity indicating a target application program in the received data and, if there is, inserting the data to the destination (i.e., if the data is identified as a short message then put the data into a newly created message, if it is an URL address then put the data to an address column of a browser and open a web page, or, otherwise, save the content to the clipboard).

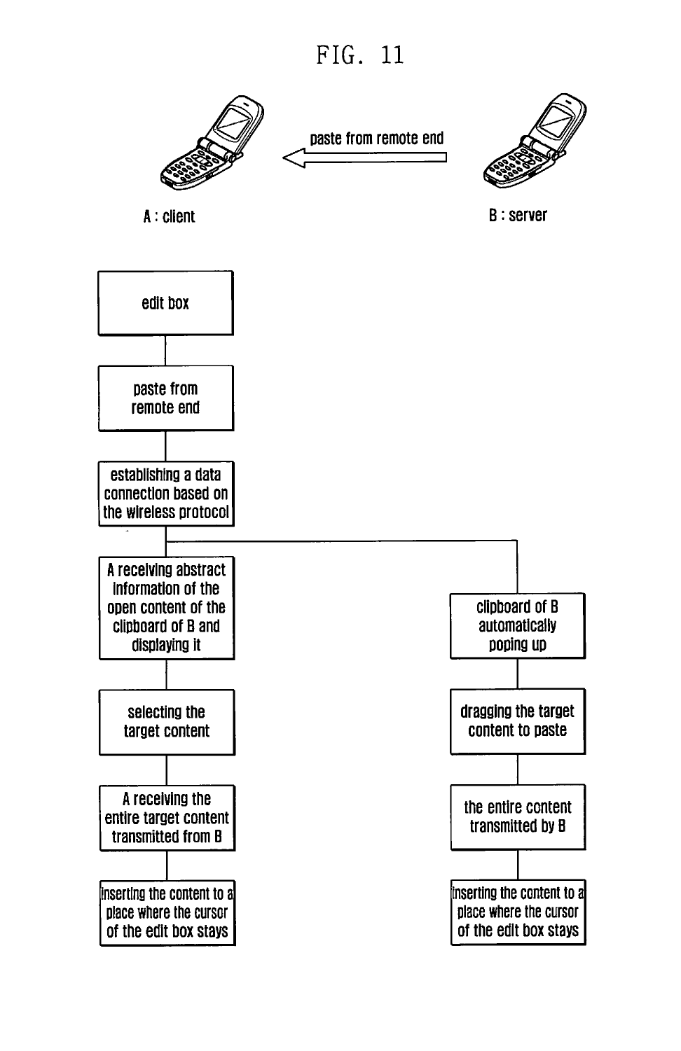

FIG. 11 is a flowchart for performing the paste-from-remote-end command between two devices of the present invention.

Referring to FIG. 11, device B is a server (i.e., Server B) and device A is a client (i.e., Client A). Operation of the server and the client is described below.

In Server B, in consideration of the data security problem, Server B sets the content in the clipboard that is open to another device.

In Client A, in the edit box module, the user selects the paste-from-remote-end command and, after the command identification module receives the command, the command identification module notifies the object management module to establish a connection with the remote device (i.e., Server B).

The data exchange between Client A and Server B may be divided into two modes.

In the first mode, after the data connection is established, Client A receives the abstract information of the open content at Server B and, to reduce transmission bandwidth and improve transmission efficiency, Server B only transmits a portion of the content to Client A. For text, only the first 10 words may be transmitted. For an image, the image may be a compressed before it is transmitted. After Client A receives the abstract information, it displays it in Client A. The user selects an object in Client A, the command identification module notifies the communication module of Server B to send the entire data to Client A, and, after the reception module of Client A receives the data from Server B, the input module inserts the content in the edit box at a location indicated by a cursor.

In the second mode, after the data connection is established, the clipboard of the Server B opens, the user confirms the target content from Server B by dragging or selecting, and confirming, etc., and the instruction identification module notifies the transmission module to send the target content to Client A. After the communication module of Client A receives the content, the input module inserts the content in the edit box at a location indicated by the cursor.

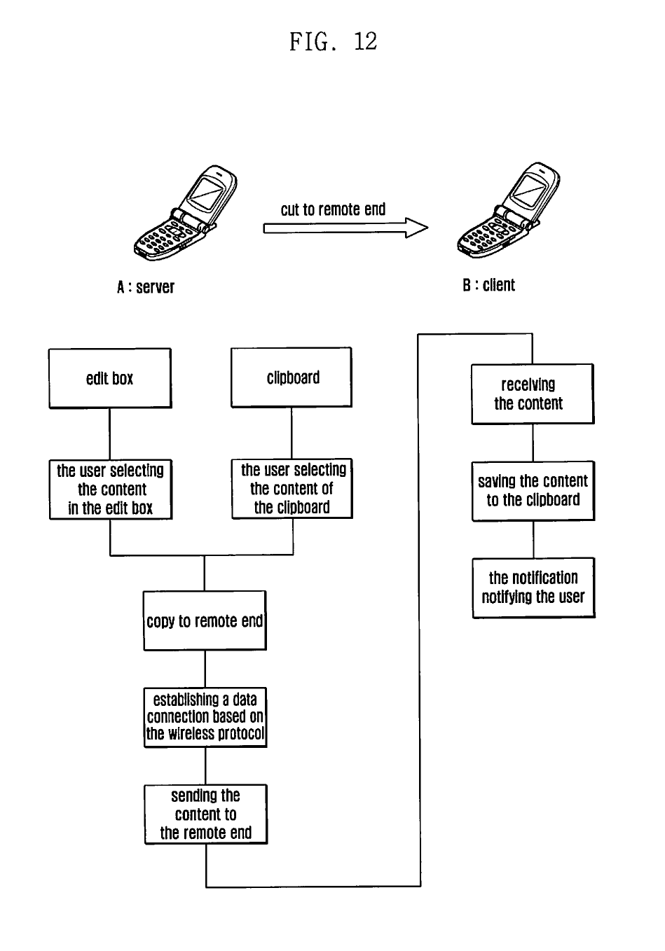

FIG. 12 is a flowchart for performing the cut-to-remote-end command between two devices of the present invention.

Referring to FIG. 12, in the embodiment, device A initiates a copy-to-remote-end command to device B and copies an operation object in device A to device B. In the embodiment, device A is a server, and device B is a client. Operation of the server and the client is described below.

In Server A (also referred to as the initiator or the sender), the user selects the content of the edit box module or the content of the clipboard module as the target content (i.e., the operation object mentioned above), the user confirms the cut-to-remote-end command, the command identification module, after receiving the command, notifies the object management module to establish a connection with the remote device (i.e., Client B), the edit box module and the clipboard module send the target content to the communication module, and, after the connection is established, the communication module sends the target content to Client B.

In Client B (also referred to as the receiver), after the communication module receives the data, the communication module informs the clipboard module of Client B to save the data, and, after the clipboard saves the data, the interface notification module notifies the user that the data was received.

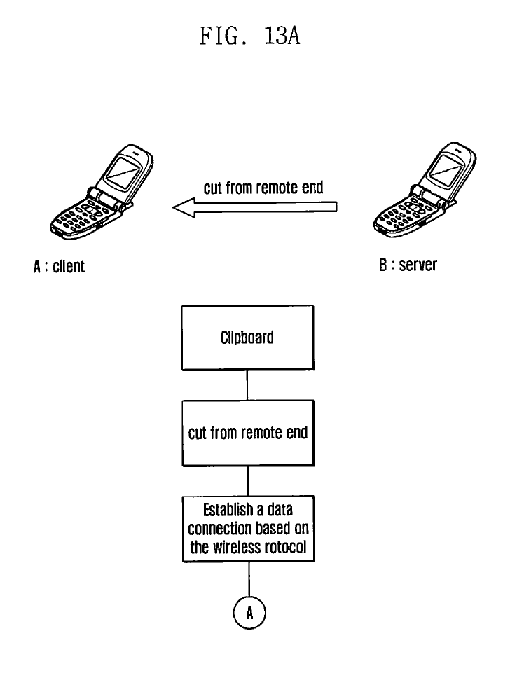

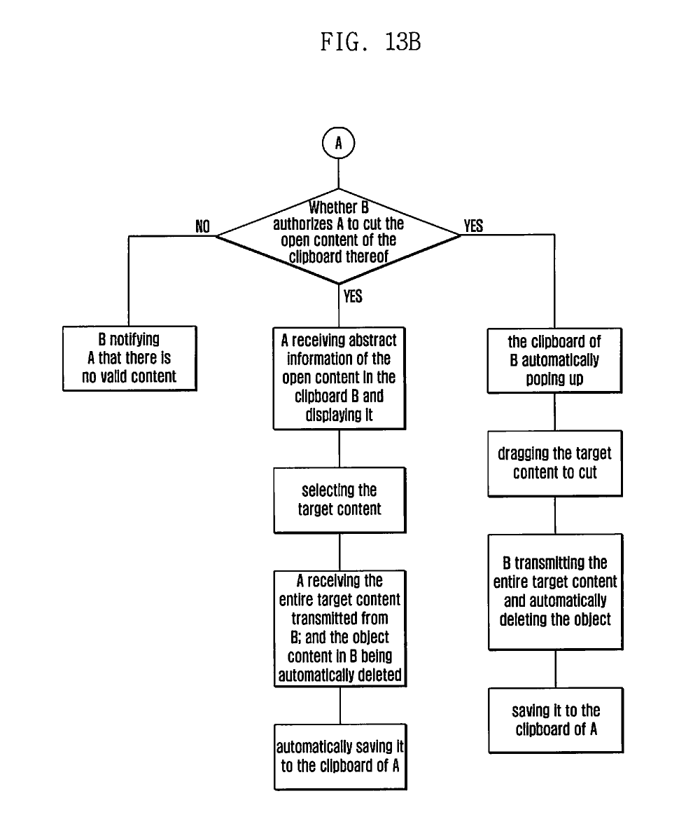

FIGS. 13A and 13B are flowcharts for performing the cut-from-remote-end command between two devices of the present invention.

Referring to FIGS. 13A and 13B, device A initiates the cut-from-remote-end command to device B to copy an operation object in device B to device A. In the embodiment, device B is a server, and device A is a client. Operation of the server and the client is described below.

In Server B, in consideration of the data security problem, Client B sets the content in the clipboard at Client B that is open to the outside (i.e., the content that may be cut to the remote end), and authorizes other devices to access the content.

In Client A, in the clipboard module, the user selects the cut-from-remote-end command and, after the command identification module receives the command, the command identification module notifies the object management module to establish a connection with the remote device (i.e., Server B). If Server B does not authorized Client A to cut the content in the clipboard, then Server B notifies Client A that either there is no valid content in the clipboard or that Client A is not authorized to cut the content from the clipboard. If Server B authorized Client A to cut the content in the clipboard then the data exchange between Client A and Server B is divided into two modes.

In the first mode, after the data connection is established, Client A receives abstract information of the open content at Server B, and, to reduce transmission bandwidth and improve transmission efficiency, Server B transmits only a portion of the content. For text, only the first 10 words may be transmitted. For an image, the image may be compressed before being transmitted. After Client A receives the abstract information, it displays it on Client A. The user selects the target content at Client A, notifies the communication module of Server B (after the command identification module receives the command) to send the entire data to Client A, and after the communication module of Client A receives the data from Server B, the communication module saves the data to the clipboard module of Client A.

In the second mode, after the data connection is established, the clipboard of the Server B opens and the user confirms the target content from Server B via dragging or selecting, and confirming, etc., and, after the command identification module identifies the command, the command identification module notifies the communication module to send the target content to Client A. After the reception module of Client A receives the content, the reception module saves the content to the clipboard of Client A.

The benefits of the present invention include convenient operation of edit commands such as copy, paste, and cut between two or more devices, the capability to maintain a user's privacy concerning content that is not to be shared with other devices, no requirement for an intermediate server or middle file, avoiding any fee, and being network independent.

The present invention is described and illustrated herein with reference to embodiments thereof. The terms, descriptions and figures used herein are set forth by way of illustration. Many variations are possible within the spirit and scope of the invention, which is defined by the following claims and their equivalents.

What is claimed is:

1. A method of performing an edit operation between devices, comprising:
receiving, by a second device, an operation object from a first device via a communication connection between the first device and the second device; and
performing, by the second device, the edit operation on the operation object, wherein the edit operation comprises saving the operation object to a clipboard, and inputting the operation object into a current edit box.

2. The method according to claim 1, wherein the second device performing the edit operation on the operation object comprises:
determining whether there is an edit box with focus and, if there is, putting the operation object into the edit box at a location indicated by a cursor;
otherwise, saving the operation object to the clipboard, determining whether the operation object is an application program and, if it is, opening a corresponding target application program and inputting the operation object into an edit box of the target application program.

3. The method according to claim 1, further comprising:
receiving, by the second device, an edit command from the first device; and
performing, by the second device, the edit operation on the operation object according to the edit command.

4. The method according to claim 3, further comprising:
if the edit command is a copy-to-remote-end or cut-to-remote-end command, the second device saves the operation object to the clipboard, and inputs the operation object into the current edit box at a location indicated by a cursor; and
if the edit command is a paste-to-remote-end command then the second device puts the operation object into the current edit box at the location indicated by the cursor, or saves the operation object to the clipboard and puts the operation object into the edit box at the location indicated by the cursor.

5. A device for performing an edit operation between devices, comprising:
a communication module configured to receive an operation object from a first device via a communication connection to the first device; and
a command identification module configured to perform the edit operation for an operation object,
wherein the edit operation comprises saving the operation object to a clipboard, and inputting the operation object into a current edit box.

6. A method of performing an edit operation between devices, comprising:
detecting by a first device an operation object selected by a user, wherein the operation object is used for the edit operation the edit operation comprising saving the operation object to a clipboard, and inputting the operation object into a current edit box, wherein the operation object selected by the user comprises is detected from the clipboard, the current edit box, a file folder, or an application program display interface, and wherein the operation object comprises text, an image, audio, or video; and
sending, by the first device, the operation object to a second device via a communication connection between the first device and the second device.

7. The method according to claim 6, further comprising detecting by the first device an edit command selected by the user, wherein the edit command is used to perform the edit operation on the operation object.

8. The method according to claim 7, further comprising:
if the edit command is a cut-to-remote-end command then cutting the operation object by the first device.

9. A device for performing an edit operation between devices, comprising:
a detection module configured to detect an operation object selected by a user, wherein the operation object is configured to perform the edit operation, and wherein the edit operation comprises saving the operation object to a clipboard, and saving the operation object into a current edit box; and
a communication module configured to send the operation object to a second device via a communication connection to the second device.

10. A method of performing an edit operation between devices, comprising:
sending, by a first device, a request to a second device and receiving a corresponding operation object from the second device via a communication connection between the first device and the second device; and
performing, by the first device, the edit operation for the operation object, wherein the edit operation comprises saving the operation object to a clipboard, and inputting the operation object into a current edit box.

11. The method according to claim 10, further comprising:
detecting, by the first device, an edit command selected by a user;
sending a request, by the first device, to the second device, wherein the first device sends the request to the second device according to the edit command; and
performing, by the first device, the edit operation on the operation object, wherein the first device performs the edit operation on the operation object.

12. The method according to claim 11, further comprising:
obtaining an operation object list, by the first device, from the second device, wherein the operation object list contains abstract information of the operation object that may be edited by the second device;
detecting, in the first device, the abstract information of the operation object selected from the operation object list by the user; and
sending, by the first device, the request to the second device requesting the operation object corresponding to the abstract information.

13. The method according to claim 11, further comprising:
sending, by the first device, the request to the second device according to the edit command, wherein the first device sends the edit command selected by the user to the second device, and wherein
the operation object that the first device receives from the second device is the operation object that the user selects after the second device informs the user of the edit command.

14. The method according to claim 11, further comprising:
if the edit command is copy-from-remote-end or cut-from-remote-end then performing, by the first device, a corresponding edit operation for the operation object according to the edit command comprises saving the operation object to the clipboard, or inputting the operation object into the current edit box at the location indicated by the cursor; and
if the edit command is paste-from-remote-end, performing, by the first device, a corresponding edit operation for the operation object according to the edit command comprises inputting the operation object into the current edit box at the location indicated by the cursor, or saving the operation object to the clipboard and saving the operation object to the current box at the location indicated by the cursor.

15. A device for performing an edit operation between devices, comprising:
a communication module configured to send a request to a second device and receive a corresponding operation object from the second device via a communication connection to the second device; and
an edit module configured to perform the edit operation on an operation object, wherein the edit operation comprises saving the operation object to a clipboard, and inputting the operation object into a current edit box.

16. A method of performing an edit operation between devices, comprising:
receiving, by a second device, a request from a first device via a communication connection between the first device and the second device;
sending, by the second device, an operation object requested by the first device to the first device to perform the edit operation, wherein the edit operation comprises saving the operation object to a clipboard, and inputting the operation object into a current edit box, wherein the operation object is an operation object corresponding to an edit command on the first device.

17. The method according to claim 16, further comprising:
receiving, by the second device, the request from the first device, wherein the second device sends an operation object list to the first device, wherein the operation object list contains abstract information of operation objects in the second device that may be edited by the first device;
receiving, by the second device, the request from the first device, wherein the request is used to obtain an operation object in the operation object list; and
sending, by the second device, the operation object corresponding to the edit command on the first device requested by the first device to the first device, wherein the second device sends the operation object requested by the first device to the first device.

18. The method according to claim 16, further comprising:
receiving, by the second device, the request from the first device, wherein the second device receives the edit command from the first device;
notifying, by the second device, the user to select an operation object according to the edit command and detecting the operation object selected by the user; and
sending, by the second device, the operation object corresponding to the edit command on the first device to the first device, wherein the second device sends the detected operation object selected by the user to the first device.

19. The method according to claim 16, further comprising:
authorizing, by the second device, the first device to perform a cut operation for the operation object, and
cutting, by the second device, the operation object.

20. A device for performing an edit operation between devices, comprising:
a communication module configured to receive a request from a first device via a communication connection with the first device; and
a command identification module configured to send an operation object request by the first device to the first device to perform the edit operation via the communication module, wherein the edit operation comprises saving the operation object to a clipboard, and inputting the operation object into a current edit box.
